(19) United States
(12) Patent Application Publication
(10) Pub. No.: US 2024/0272651 A1
(43) Pub. Date: Aug. 15, 2024

(54) PLATOON TRAVELING SYSTEM

(71) Applicant: TOYOTA JIDOSHA KABUSHIKI KAISHA, Toyota-shi (JP)

(72) Inventors: Kizuku YAMADA, Susono-shi (JP); Yasuhiro IMAI, Tokyo (JP)

(73) Assignee: TOYOTA JIDOSHA KABUSHIKI KAISHA, Toyota-shi (JP)

(21) Appl. No.: 18/403,781

(22) Filed: Jan. 4, 2024

(30) Foreign Application Priority Data
Feb. 13, 2023 (JP) 2023-019790

(51) Int. Cl. G05D 1/695; G08G 1/00

(52) U.S. Cl. CPC G05D 1/695; G08G 1/22; G05D 2101/20

(57) ABSTRACT

A platoon traveling system includes a control device, provided in an own vehicle, that performs control to propose the own vehicle to follow a surrounding vehicle traveling around the own vehicle. Further, the control device does not propose to follow the surrounding vehicle traveling on a passing lane.

### CROSS-REFERENCE TO RELATED APPLICATION (S)

The present application claims priority to and incorporates by reference the entire contents of Japanese Patent Application No. 2023-019790 filed in Japan on Feb. 13, 2023.

### BACKGROUND

The present disclosure relates to a platoon traveling system.

International Publication No. 2020/162343 discloses a vehicle management device capable of managing platoon traveling by appropriately determining whether to perform the platoon traveling on the basis of a condition of a road on which vehicles perform the platoon traveling.

### SUMMARY

There is a need for providing a platoon traveling system capable of preventing the own vehicle from continuing to travel in a passing lane in platoon traveling.

According to an embodiment, a platoon traveling system includes a control device, provided in an own vehicle, that performs control to propose the own vehicle to follow a surrounding vehicle traveling around the own vehicle. Further, the control device does not propose to follow the surrounding vehicle traveling on a passing lane.

According to an embodiment, a platoon traveling system includes a control device, provided in an own vehicle, that performs control to propose an own vehicle to follow a surrounding vehicle traveling around the own vehicle. Further, the control device performs control to make a proposal to stop following the surrounding vehicle in a case where the surrounding vehicle makes a lane change to a passing lane after the control device proposes to follow the surrounding vehicle traveling on a lane other than the passing lane.

### BRIEF DESCRIPTION OF THE DRAWINGS

FIG. 1 is a view for describing an example of an own vehicle including a platoon traveling system according to an embodiment;

FIG. 2 is a view illustrating an example of a system configuration of an ECU;

FIG. 3 is a flowchart illustrating a first example of control executed by the ECU in the own vehicle when a preceding vehicle in platoon traveling is selected from surrounding vehicles;

FIG. 4 is a view illustrating a case where a surrounding vehicle is not traveling in a passing lane;

FIG. 5 is a view illustrating a state in which the surrounding vehicle is traveling in the passing lane;

FIG. 6 is a flowchart illustrating a second example of the control executed by the ECU in the own vehicle when a preceding vehicle in the platoon traveling is selected from surrounding vehicles;

FIG. 7 is a view illustrating a case where a surrounding vehicle not traveling in the passing lane changes the lane to the passing lane after a proposal to follow the surrounding vehicle is made;

FIG. 8 is a view illustrating a case where the own vehicle is traveling in the passing lane;

FIG. 9 is a view illustrating a case where the leftmost lane of three lanes on each side is the passing lane;

FIG. 10 is a view illustrating a first example of a case where the total number of lanes is two on each side;

FIG. 11 is a view illustrating a second example of a case where the total number of lanes is two on each side;

FIG. 12 is a flowchart illustrating a third example of the control executed by the ECU in the own vehicle when a preceding vehicle in the platoon traveling is selected from surrounding vehicles;

FIG. 13 is a view illustrating a third example of a case where the total number of lanes is two on each side; and

FIG. 14 is a flowchart illustrating a fourth example of the control executed by the ECU in the own vehicle when a preceding vehicle in the platoon traveling is selected from surrounding vehicles.

### DETAILED DESCRIPTION

In the related art, when it is proposed to follow a vehicle traveling in a passing lane in order to perform platoon traveling, there is a possibility that an own vehicle continuously travels in the passing lane in the platoon traveling.

Hereinafter, an embodiment of a platoon traveling system according to the present disclosure will be described. Note that the present disclosure is not limited to the present embodiment. A vehicle that includes the platoon traveling system and that can be a target of the present disclosure is a vehicle that can travel in a manner of following a preceding vehicle without being operated by a driver. Specifically, a configuration is made in such a manner that traveling can be performed while an inter-vehicle distance with the preceding vehicle is maintained to be an appropriate distance with driving force and braking force being controlled without an accelerator operation or brake operation by the driver. Examples of the control capable of performing such follow-up traveling include cruise control known in the related art, adaptive cruise control (ACC) that maintains a constant inter-vehicle distance from a preceding vehicle and stops the own vehicle when the preceding vehicle stops, and cooperative adaptive cruise control (CACC) that enables platoon traveling of the own vehicle and the preceding vehicle (including front and rear vehicles) by setting a relatively short inter-vehicle distance between the own vehicle and the preceding vehicle by using vehicle-to-vehicle communication. Note that these kinds of cruise control and the like are executed by, for example, a switch operation by the driver or a passenger, or executed by signals from various sensors.

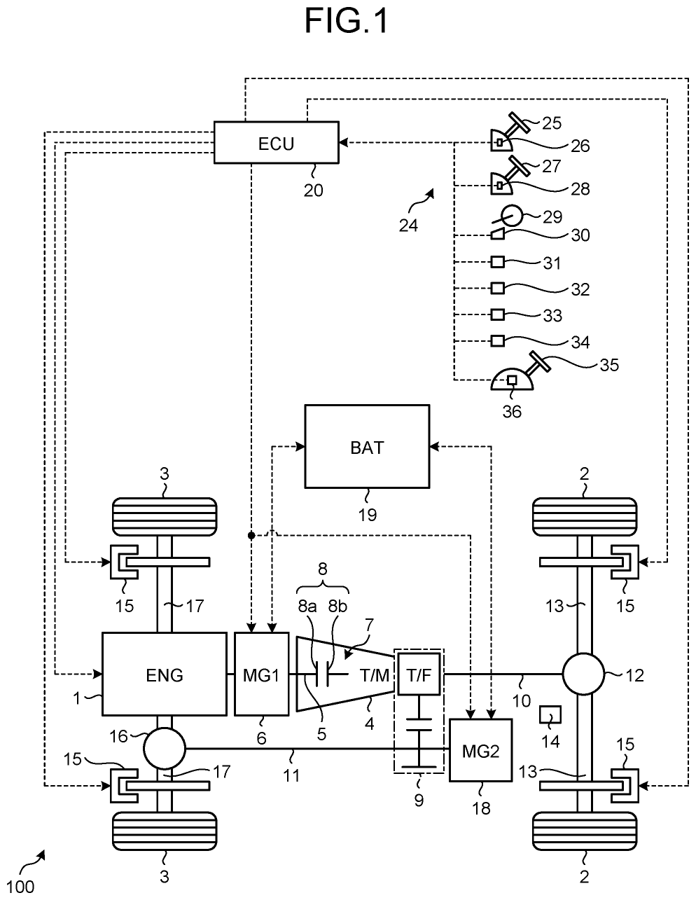

FIG. 1 is a view for describing an example of an own vehicle 100 including a platoon traveling system according to an embodiment. As illustrated in FIG. 1, the own vehicle 100 including the platoon traveling system according to the embodiment is an example of a four-wheel-drive vehicle based on a so-called front engine rear drive (FR) vehicle in which an engine (ENG) 1 is arranged on a front side of the own vehicle 100 and power of the engine 1 is transmitted to rear wheels 2. In addition, the engine 1 is arranged between right and left front wheels 3 (substantially at a center portion in a width direction of a vehicle body) on a side of the front wheels 3 toward a side of the rear wheels 2. Note that the own vehicle 100 may be a four-wheel-drive vehicle based on a so-called front engine front drive (FF) vehicle.

A transmission (T/M) 4 is arranged on an output side of the engine 1, and an output shaft (not illustrated) of the engine 1 is coupled to an input shaft 5 of the transmission 4. The engine 1 is, for example, an internal combustion engine such as a gasoline engine or a diesel engine, and is configured in such a manner that a throttle opening and a fuel injection amount are controlled according to request driving force such as a pedaling amount of an accelerator pedal (not illustrated) (accelerator opening) and torque corresponding to the request driving force is output. In a case of the gasoline engine, an opening degree of a throttle valve, a supply amount or an injection amount of fuel, execution and stopping of ignition, an ignition timing, and the like are electrically controlled. In a case of the diesel engine, an injection amount of fuel, an injection timing of the fuel, an opening degree of a throttle valve in an exhaust gas recirculation (EGR) system, and the like are electrically controlled.

As illustrated in FIG. 1, the transmission 4 is arranged on the same axis as the engine 1, and transmits torque between the engine 1 and a first motor (MG1) 6 and a driving wheel. This transmission 4 is a mechanism capable of appropriately changing a ratio of an input rotation speed to an output rotation speed, and can include a stepped transmission, a continuously-variable transmission capable of continuously changing a transmission ratio, or the like. More preferably, the transmission 4 includes a clutch mechanism 7 capable of transmitting torque by engagement, and cutting off transmission of the torque by disengagement and setting a neutral state.

The clutch mechanism 7 selectively transmits and cuts off power between the engine 1 (and the first motor 6) and the driving wheel. In the example illustrated in FIG. 1, the clutch mechanism 7 is provided in the transmission 4 in the above-described manner. Specifically, the clutch mechanism 7 includes a friction plate 8 (8a) coupled to a rotary member (not illustrated) on a side of the engine 1 and a friction plate 8 (8b) coupled to a rotary member (not illustrated) on a side of the rear wheels 2. Although not illustrated in FIG. 1, the clutch mechanism 7 may include, for example, a multi-disc clutch which includes a plurality of friction plates on one side and a plurality of friction plates on the other side, and in which the plurality of friction plates on the one side and the plurality of friction plates on the other side are alternately arranged. In addition, in the own vehicle 100 according to the embodiment, the clutch mechanism 7 is not limited to the clutch mechanism incorporated in the transmission 4 in a manner illustrated in FIG. 1, and may be, for example, a friction clutch provided as a start clutch between the first motor 6 and the transmission 4. In any case, by disengagement of the clutch mechanism 7, the engine 1 and the first motor 6 are disconnected from a drive system of the own vehicle 100. Furthermore, by the engagement of the clutch mechanism 7, the engine 1 and the first motor 6 are coupled to the drive system of the own vehicle 100.

The engine 1 and the transmission 4 are arranged on the same axis as described above, and the first motor 6 is arranged between the engine 1 and the transmission 4. The first motor 6 has a function as a generator that generates electricity by being driven by reception of engine torque output from the engine 1 (power generation function), and also has a function as an electric motor that is driven by being supplied with electric power and that outputs motor torque (electric motor function). That is, the first motor 6 is a motor having a power generation function (so-called motor generator), and includes, for example, a permanent magnet synchronous motor, an induction motor, or the like. Note that the first motor 6 may be directly coupled to the output shaft of the engine 1 or the input shaft 5 of the transmission 4, or may be coupled to the output shaft of the engine 1 or the input shaft 5 of the transmission 4 via an appropriate transmission mechanism.

A four-wheel-drive transfer (T/F) 9 is arranged on an output side of the transmission 4. The transfer 9 is a mechanism that distributes the power output from the engine 1 or the torque output from the transmission 4 to the side of the rear wheels 2 and the side of the front wheels 3. A rear propeller shaft 10 is coupled to a member that outputs torque to the side of the rear wheels 2 (not illustrated), and a front propeller shaft 11 is coupled to a member that outputs torque to the side of the front wheels 3 (not illustrated).

The transfer 9 can include a winding transmission mechanism using a chain or a belt, or a gear mechanism. In addition, the transfer 9 can include a full-time four-wheel-drive mechanism including a differential mechanism that enables a differential rotation between the front wheels 3 and the rear wheels 2 and a differential limiting mechanism that limits the differential rotation with a friction clutch or the like, a part-time four-wheel-drive mechanism that selectively cuts off transmission of torque to the side of the front wheels 3, or the like.

The rear propeller shaft 10 extends from the transmission 4 or the transfer 9 to the rear side of the own vehicle 100, and is coupled to a rear differential gear 12. The rear differential gear 12 is a final reduction gear that transmits torque to the right and left rear wheels 2, and the rear wheels 2 are coupled to the rear differential gear 12 via two drive shafts 13 extending in a vehicle width direction. The rear wheels 2 are configured in such a manner that a steering angle thereof is changed by a steering device 14. That is, the right and left rear wheels 2 also function as steering wheels. Furthermore, in the own vehicle 100 illustrated in FIG. 1, a braking device (brake) 15 to apply braking force to each of the rear wheels 2 and the front wheels 3 is coupled. Furthermore, the front propeller shaft 11 extends toward the front side of the own vehicle 100 and is coupled to a front differential gear 16. Note that the front differential gear 16 is a final reduction gear that transmits torque to the right and left front wheels 3, and the front wheels 3 are coupled to the front differential gear 16 via two drive shafts 17 extending in the vehicle width direction.

In addition, a second motor (MG2) 18 that drives the front propeller shaft 11 is coupled to the transfer 9. The second motor 18 is a motor that mainly outputs driving torque for traveling. Note that in order to perform energy regeneration at the time of deceleration, the second motor 18 preferably includes a motor generator having a power generation function, such as a permanent magnet synchronous motor similarly to the first motor 6 described above.

The first motor 6 and the second motor 18 are electrically connected to an electric storage device (BAT) 19 such as a storage battery or a capacitor via an inverter (not illustrated). Thus, it is possible to cause the first motor 6 and the second motor 18 to function as motors by electric power of the electric storage device 19, or to charge electric power generated by the motors 6 and 18 into the electric storage device 19. In addition, it is also possible to cause the second motor 18 to function as an electric motor by the electric power generated by the first motor 6, and to perform traveling by torque of the second motor 18.

In addition, the own vehicle 100 according to the embodiment can travel in a plurality of traveling modes by controlling each of the engine 1, the first motor 6, the second motor 18, and the clutch mechanism 7. That is, the own vehicle 100 travels by setting any of an EV traveling mode in which the motor torque output from the second motor 18 is transmitted to the drive wheel and the driving force is generated in a state in which the engine 1 is stopped, a series HV traveling mode in which the engine 1 is operated in a state in which the clutch mechanism 7 is disengaged, the first motor 6 is caused to generate the power by being driven by the engine torque, and the motor torque of the second motor 18 is transmitted to the drive wheel and the driving force is generated, or a parallel HV traveling mode in which the engine 1 is operated in a state in which the clutch mechanism 7 is engaged, and the driving force is generated by transmission of the engine torque and the motor torque of the second motor 18 to the driving wheel. Such switching of the traveling modes is set by utilization of a mode switching map or the like using the request driving force and the vehicle speed as parameters, for example. Note that the own vehicle 100 according to the embodiment can be also switched between a four-wheel-drive mode (4WD) and a two-wheel-drive mode (2WD), and such switching of the traveling modes may be controlled, for example, by operation of a mode switching switch by the driver or on the basis of a friction coefficient of a road surface or the like.

Then, an electronic control unit (ECU) 20 that controls the engine 1, the transmission 4, the clutch mechanism 7, the transfer 9, the motors 6 and 18, and the like are provided in the own vehicle 100. The ECU 20 mainly includes a microcomputer, and is configured to perform calculation by using input data, and data and a program stored in advance, and to output a result of the calculation as a control command signal.

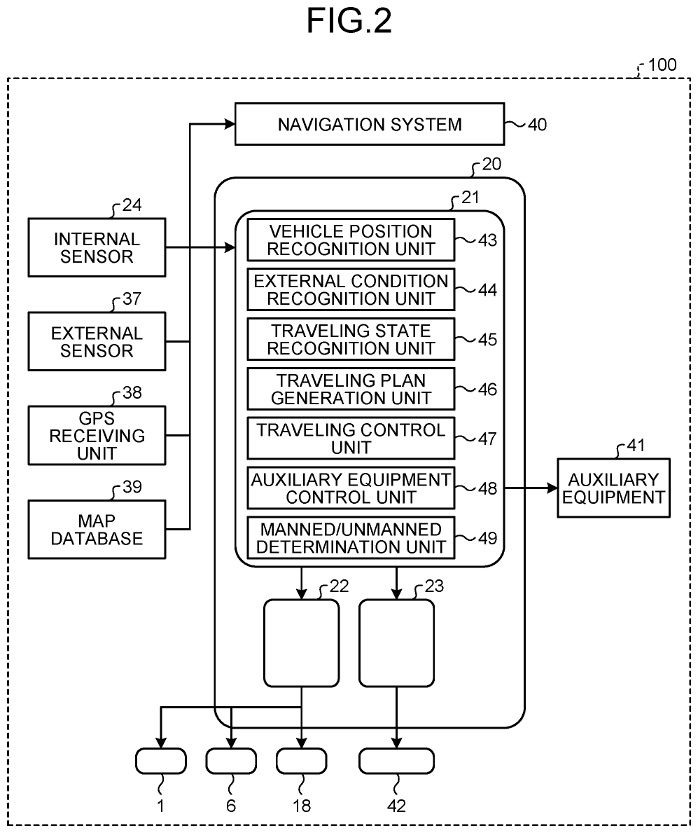

FIG. 2 is a view illustrating an example of a system configuration of the ECU 20. As illustrated in FIG. 2, the ECU 20 includes a main controller 21, and a driving controller 22 and a sub-controller 23 to which a signal output from the main controller 21 is input and which convert the input signal. The driving controller 22 is configured to output a signal to a throttle actuator provided in the engine 1, an inverter (not illustrated) provided in each of the motors 6 and 18, and the like. The sub-controller 23 is configured to output signals to actuators provided in various devices such as the clutch mechanism 7.

The main controller 21 mainly includes a microcomputer, and signals are input thereto from main internal sensors 24 that detect a traveling state of the own vehicle 100, and a working state, a behavior, and the like of each unit. The internal sensors 24 are, for example, an accelerator sensor 26 that detects a pedaling amount of an accelerator pedal 25, a brake sensor (or brake switch) 28 that detects a pedaling amount of a brake pedal 27, a steering angle sensor 30 that detects a steering angle of the steering 29, a vehicle speed sensor 31 that detects a rotational speed of each of the rear wheels 2 and the front wheels 3, a longitudinal acceleration sensor 32 that detects longitudinal acceleration of the own vehicle 100, a lateral acceleration sensor 33 that detects lateral acceleration of the own vehicle 100, a yaw rate sensor 34 that detects a yaw rate of the own vehicle 100, a shift sensor 36 that detects a position of a shift lever (or shift switch) 35, and the like. A signal for controlling the engine 1 and each of the motors 6 and 18 is output to the driving controller 22, and a signal for controlling the clutch mechanism 7 and the like is output to the sub-controller 23 on the basis of the signals input from the internal sensors 24, an arithmetic expression or a map stored in advance, or the like. Note that as examples of the input or output signals, the signals input from the internal sensors 24 to the ECU 20 and signals output from the ECU 20 to the engine 1, the motors 6 and 18, and the braking device 15 are indicated by broken lines in FIG. 1.

Furthermore, the own vehicle 100 to be controlled in the embodiment can perform automatic driving in which the driving operation of the own vehicle 100 is automatically controlled to travel. The automatic driving defined in the embodiment is automatic driving in which a control system of the own vehicle 100 performs all driving operations such as recognition of a traveling environment, monitoring of a peripheral condition, start/acceleration, steering, and braking/stopping. For example, advanced automatic driving or fully automatic driving corresponding to a “level 4” in an automation level formulated by National Highway Traffic Safety Administration (NHTSA) or a “level 4” and a “level 5” in an automation level formulated by Society of Automotive Engineers (SAE) of the United States is performed. Thus, the own vehicle 100 to be controlled in the embodiment can travel by the automatic driving even in a condition in which there is no passenger (such as a driver, fellow passenger, or occupant) in the vehicle. That is, the own vehicle 100 can perform manned automatic driving in which traveling is performed by the automatic driving in a state in which a passenger is present in the vehicle, and unmanned automatic driving in which traveling is performed by the automatic driving in a state in which no passenger is present in the vehicle. Note that the own vehicle 100 may be configured to be able to select, for example, an automatic driving mode in which traveling is performed by the automatic driving and a manual driving mode in which the driver performs the driving operation of the own vehicle 100 as defined in the “level 4” in the automation level of the SAE.

Thus, the own vehicle 100 can perform so-called automatic driving traveling in which traveling is performed by automatic controlling of the motors 6 and 18, the braking device 15, or the steering device 14 without the driving operation by the passenger (person). The ECU 20 also controls the motors 6 and 18, the steering device 14, the braking device 15, and the like at the time of such automatic driving traveling.

Signals are input to the main controller 21 from main external sensors 37 that detect peripheral information and an external condition of the own vehicle 100 in addition to the internal sensors 24 in order to perform the automatic driving traveling. The external sensor 37 is, for example, an in-vehicle camera, radio detection and ranging (RADAR), laser imaging detection and ranging (LIDAR), vehicle-to-vehicle communication, and the like.

The in-vehicle camera is, for example, an imaging device installed inside a windshield of the own vehicle 100, and is configured to photograph a periphery of the own vehicle 100 and transmit imaging information (image) related to the photographed external condition to the main controller 21. The in-vehicle camera may be a monocular camera or a stereo camera. The stereo camera includes a plurality of imaging units arranged to reproduce binocular parallax. According to the imaging information of the stereo camera, information in a depth direction on a front side of the vehicle can also be acquired.

The RADAR is configured to detect another vehicle, an obstacle, and the like outside the own vehicle 100 by using radio waves such as a millimeter wave and a microwave, and to transmit detection data thereof to the main controller 21. For example, the radio waves are emitted to the surroundings of the own vehicle 100, and the radio waves reflected by the other vehicle, the obstacle, and the like are received and measured/analyzed, whereby the other vehicle, the obstacle, and the like are detected.

The LIDAR is configured to detect another vehicle, an obstacle, and the like outside the own vehicle 100 by using laser light, and transmit detection data thereof to the main controller 21. For example, the laser light is emitted to the surroundings of the own vehicle 100, and the laser light reflected by the other vehicle, the obstacle, and the like is received and measured/analyzed, whereby the other vehicle, the obstacle, and the like are detected.

The vehicle-to-vehicle communication (inter-vehicle communication) is a system that acquires information (such as a destination, a position, a speed, a traveling direction, vehicle control information, and the like) of a surrounding vehicle by wireless communication between the vehicles, and provides safe driving support to the driver and the passenger as necessary. Furthermore, in this vehicle-to-vehicle communication, a service can be received by an information exchange between vehicles on which in-vehicle devices of an Intelligent Transport Systems (ITS) safe driving support wireless system are mounted, and the service can be received at an unspecified place where infrastructure facilities are not provided. Thus, the service can be received even in a place where installation of the infrastructure facilities is difficult.

Signals are input to the main controller 21 from a global positioning system (GPS) receiving unit 38, a map database 39, a navigation system 40, and the like in addition to the internal sensors 24 and the external sensors 37 described above. The GPS receiving unit 38 is a position information acquisition unit configured to measure a position of the own vehicle 100 (such as latitude and longitude of the own vehicle 100) by receiving radio waves from a plurality of GPS satellites, and to transmit the position information to the main controller 21. The map database 39 is a database in which the map information is accumulated, and data stored in a computer of an external facility such as an information processing center that can communicate with the own vehicle 100 can be used, for example. Note that the above-described computer of the external facility includes the above-described vehicle-to-vehicle communication, road-to-vehicle communication between the own vehicle 100 and communication equipment, a sign post, or the like installed outside on a road or beside the road, so-called big data accumulated in a server (not illustrated) such as an external data center and updated as needed, and the like. Furthermore, the map database 39 may be stored inside the main controller 21. The navigation system 40 is configured to calculate a traveling route of the own vehicle 100 on the basis of the position information of the own vehicle 100 which information is measured by the GPS receiving unit 38, and the map information in the map database 39. Note that the map information in the map database 39 also includes information related to lanes on roads (such as information of the number of lanes (two lanes on each side and three lanes on each side) and a vehicle traffic zone (driving lane and passing lane)). Then, for example, the navigation system 40 can specify a lane on which the own vehicle 100 is traveling and calculate a traveling route of the own vehicle 100.

The main controller 21 performs calculation by using the detection data and the information data input from the internal sensors 24, the external sensors 37, and the like, data stored in advance, and the like, and outputs signals to the driving controller 22, the sub-controller 23, and auxiliary equipment 41 on the basis of a result of the calculation. Then, the driving controller 22 is configured to output control command signals to the engine 1 (including the throttle valve) and the actuators of the motors 6 and 18, and the sub-controller 23 is configured to output a control command signal to the actuator of each unit of the own vehicle 100, such as the braking device 15 and the steering device 14. Note that the actuators may be simply referred to as actuators 42 without distinction in the following description.

A brake actuator, a steering actuator, and the like are included as the main actuators 42 for causing the own vehicle 100 to perform the automatic driving traveling. The brake actuator is configured to make the braking device 15 work in response to a control signal output from the sub-controller 23 and to control braking force applied to the rear wheels 2 and the front wheels 3. The steering actuator is configured to control steering torque by driving an assist motor of an electric power steering device in response to a control signal output from the sub-controller 23.

The auxiliary equipment 41 is equipment or a device that is not included in the actuators 42, and is, for example, the equipment/device that is not directly involved in the driving operation of the own vehicle 100, examples thereof including a wiper, a headlight, a direction indicator, an air conditioner, and an audio device.

The main controller 21 includes, as main control units to cause the own vehicle 100 perform the automatic driving traveling, a vehicle position recognition unit 43, an external condition recognition unit 44, a traveling state recognition unit 45, a traveling plan generation unit 46, a traveling control unit 47, an auxiliary equipment control unit 48, a manned/unmanned determination unit 49, and the like, for example.

The vehicle position recognition unit 43 is configured to recognize a position of the own vehicle 100 on the map on the basis of the position information of the own vehicle 100 which information is received by the GPS receiving unit 38, and the map information in the map database 39. Note that the position of the own vehicle 100 which position is used in the navigation system 40 can be also acquired from the navigation system 40. Alternatively, in a case where the position of the own vehicle 100 can be measured by a sensor installed outside on the road or the road side, the position of the own vehicle 100 can be acquired by communication with the sensor.

The external condition recognition unit 44 is configured to recognize the external condition of the own vehicle 100 on the basis of, for example, the imaging information of the in-vehicle camera or the detection data of the RADAR or the LIDAR. As the external condition, for example, information related to a position of a lane (vehicle traffic zone), a road width, a shape of a road, a road surface grade, an obstacle around the vehicle, and the like are acquired. In addition, as a traveling environment, a periphery of the own vehicle 100, topography/weather information of a traveling route, a road shape, a friction coefficient of the road surface, and the like may be acquired.

The traveling state recognition unit 45 is configured to recognize the traveling state of the own vehicle 100 on the basis of various kinds of detection data of the internal sensors 24. As the traveling state of the own vehicle 100, for example, a vehicle speed, longitudinal acceleration, lateral acceleration, a yaw rate, and the like are acquired.

The traveling plan generation unit 46 is configured to generate a course of the own vehicle 100 on the basis of, for example, a target route calculated by the navigation system 40, the position of the own vehicle 100 which position is recognized by the vehicle position recognition unit 43, the external condition recognized by the external condition recognition unit 44, and the like. The course is a track in which the own vehicle 100 moves along the target route. In addition, the traveling plan generation unit 46 generates the course in such a manner that the own vehicle 100 can appropriately travel on the target route according to standards such as traveling safely, traveling in compliance with laws and regulations, and traveling efficiently.

Then, the traveling plan generation unit 46 is configured to generate a traveling plan corresponding to the generated course. Specifically, the traveling plan along the preset target route is generated on the basis of at least the external condition recognized by the external condition recognition unit 44 and the map information in the map database 39.

The traveling plan is to previously set the traveling state of the own vehicle 100 which state includes a future driving force request of the own vehicle 100, and is generated on the basis of, for example, future data at a several seconds from current time. Depending on the external condition or traveling condition of the own vehicle 100, future data at several ten seconds from the current time can be also used. The traveling plan is output from the traveling plan generation unit 46 as data indicating changes in the vehicle speed, the acceleration, the steering torque, and the like when the own vehicle 100 travels in the course along the target route, for example.

Furthermore, the traveling plan can also be output from the traveling plan generation unit 46 as a speed pattern, an acceleration pattern, and a steering pattern of the own vehicle 100. The speed pattern is, for example, data including a target vehicle speed set in association with time for each target control position with respect to target control positions set at predetermined intervals on the course. The acceleration pattern is, for example, data including target acceleration set in association with time for each target control position with respect to the target control positions set at the predetermined intervals on the course. The steering pattern is, for example, data including target steering torque set in association with time for each target control position with respect to the target control positions set at the predetermined intervals on the course.

Furthermore, the traveling plan includes a traveling plan in which the own vehicle 100 follows a preceding vehicle, and examples thereof include cruise control known in the related art and adaptive cruise control (ACC), and cooperative adaptive cruise control (CACC) in which follow-up control is performed by vehicle-to-vehicle communication. Switching of the cruise control and the like is performed by an input operation switch group attached to a side of a steering wheel or to a steering pad, and activation and stopping of the system, switching of control modes, an input of a set vehicle speed, setting of a target inter-vehicle distance (set in three stages of long, medium, and short, for example), and the like are performed.

The traveling control unit 47 is configured to automatically control the traveling of the own vehicle 100 on the basis of the traveling plan generated by the traveling plan generation unit 46. Specifically, a control signal corresponding to the traveling plan is output to the engine 1, each of the motors 6 and 18, or the actuator 42 via the driving controller 22 and the sub-controller 23. As a result, the own vehicle 100 performs the automatic driving traveling.

The auxiliary equipment control unit 48 is configured to automatically control the auxiliary equipment 41 on the basis of the traveling plan generated by the traveling plan generation unit 46. Specifically, a control signal corresponding to the traveling plan is output to the auxiliary equipment 41 such as the wiper, the headlight, the direction indicator, the air conditioner, and the audio device as necessary.

The manned/unmanned determination unit 49 determines whether a passenger is present in the own vehicle 100 and the preceding vehicle. Specifically, in the own vehicle 100, the presence or absence of the passenger is determined on the basis of an operation condition or a working state of a device provided in a vehicle interior, for example, in a case where a power switch, an ignition key switch, or a start button switch is operated to be ON, in a case where a seat occupancy sensor detects that a person is on a seat, in a case where a seat belt wearing sensor detects that a seat belt is worn, or in a case where a steering wheel is operated. In addition, a biological sensor or a moving object detection sensor such as an infrared sensor or a Doppler sensor may be provided and it may be determined whether the passenger is present in the vehicle by detection of a body temperature or a motion of the passenger. Note that in the preceding vehicle, information of the preceding vehicle is acquired by wireless communication by the above-described vehicle-to-vehicle communication, or presence or absence of a passenger of the preceding vehicle is determined by an in-vehicle camera or the like in the own vehicle 100.

As described above, the own vehicle 100 illustrated in FIG. 1 can travel by so-called automatic driving. In the automatic driving, as described above, the vehicles transmit and receive vehicle information such as positions and speeds of each other by the vehicle-to-vehicle communication or the like, and the own vehicle and the preceding vehicle or a following vehicle can perform the platoon traveling by using the information. Note that the platoon traveling means a mode in which a plurality of vehicles travels in a group while maintaining relative positions with each other.

In the platoon traveling system according to the embodiment, when selecting a preceding vehicle in the platoon traveling from one or more surrounding vehicles traveling around the own vehicle 100, the ECU 20 of the own vehicle 100 performs control to determine a lane on which the surrounding vehicle is traveling, not to propose to follow a surrounding vehicle traveling on the passing lane, and to propose to follow a surrounding vehicle not traveling on the passing lane.

In addition, the ECU 20 proposes to follow the surrounding vehicle to a driver (passenger) by presenting the proposal by using, for example, an information panel or the like that is a proposal device provided inside the own vehicle 100. Then, for example, the driver (passenger) executes permission to follow the surrounding vehicle from an operation panel or the like in the vehicle in response to the proposal, whereby the platoon traveling in which the own vehicle 100 performs follow-up travelling with the surrounding vehicle as the preceding vehicle can be executed by automatic driving. In addition, in response to the proposal, the driver may execute the platoon traveling by manual driving and causes the own vehicle 100 to perform the follow-up traveling with the surrounding vehicle as the preceding vehicle.

In the platoon traveling system according to the embodiment, the ECU 20 of the own vehicle 100 can recognize the lane on which the own vehicle 100 is traveling by using the vehicle position recognition unit 43, the external condition recognition unit 44, and the like. For example, the ECU 20 can recognize the lane on which the own vehicle 100 is traveling by recognizing the position of the own vehicle 100 on the map by the vehicle position recognition unit 43 on the basis of the position information of the own vehicle 100 which information is received by the GPS receiving unit 38 and the map information in the map database 39. In addition, the ECU 20 can recognize the lane on which the own vehicle 100 is traveling by the external condition recognition unit 44 by image recognition using the image captured by the in-vehicle camera.

Furthermore, in the platoon traveling system according to the embodiment, the ECU 20 of the own vehicle 100 can recognize the lane, on which the surrounding vehicle around the own vehicle 100 is traveling, by using, for example, the vehicle position recognition unit 43, the external condition recognition unit 44, and the like. For example, the ECU 20 causes the vehicle position recognition unit 43 to recognize the lane on which the own vehicle 100 is traveling as described above on the basis of the position information of the own vehicle 100 which information is received by the GPS receiving unit 38 and the map information in the map database 39, and to recognize the position of the surrounding vehicle on the map depending on, for example, whether the surrounding vehicle is located on a left side, a front side, or a right side of the own vehicle 100 in the traveling direction, whereby the lane on which the surrounding vehicle is traveling can be recognized. Furthermore, the ECU 20 can recognize the lane on which the surrounding vehicle is traveling by the image recognition by the in-vehicle camera by the external condition recognition unit 44.

In addition, in the platoon traveling system according to the embodiment, determination whether the surrounding vehicle is traveling on the passing lane may be performed by utilization of artificial intelligence (AI). For example, the ECU 20 inputs a plurality of input parameters to a neural network model and causes the neural network model to output at least one output parameter. At this time, for example, the position information of the own vehicle 100 and a surrounding vehicle 110 recognized by utilization of the GPS receiving unit 38 and the map information in the map database 39 are used as the input parameters. Then, by using the neural network model, the ECU 20 can acquire an appropriate output parameter corresponding to each of the input parameters as a result of the determination whether the surrounding vehicle 110 is traveling on the passing lane.

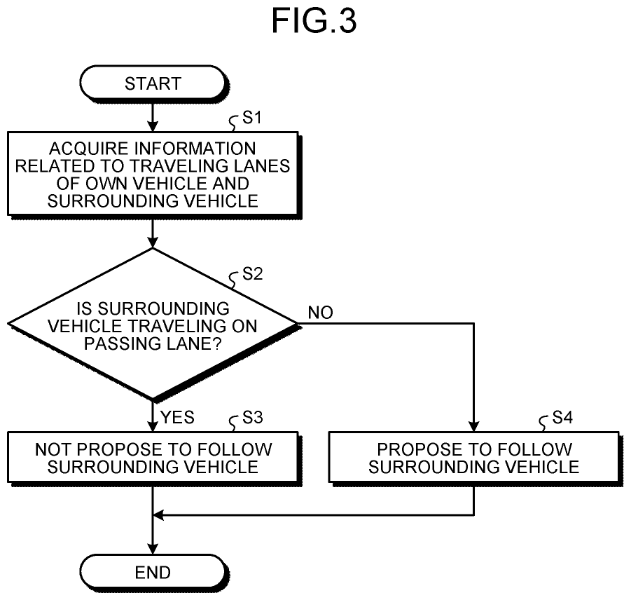

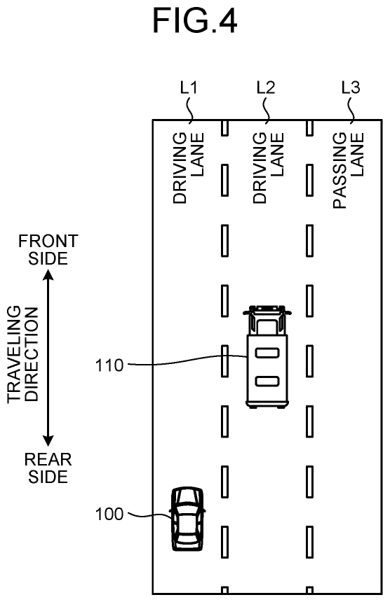

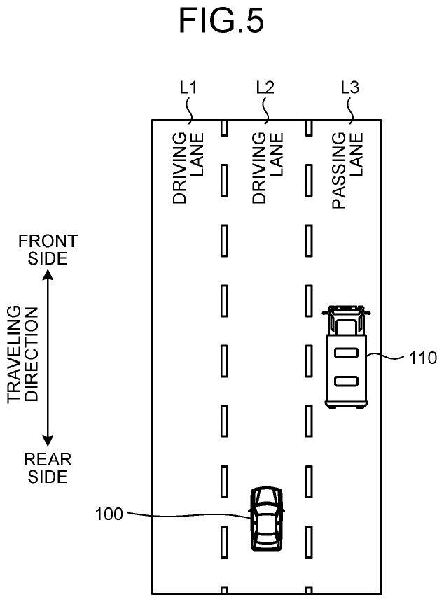

FIG. 3 is a flowchart illustrating a first example of control executed by the ECU 20 in the own vehicle 100 when the preceding vehicle in the platoon traveling is selected from the surrounding vehicles. FIG. 4 is a view illustrating a case where the surrounding vehicle 110 is not traveling on the passing lane. FIG. 5 is a view illustrating a state in which the surrounding vehicle 110 is traveling on the passing lane.

Note that in FIG. 4, the total number of lanes is three on each side, a first vehicle traffic zone L1 and a second vehicle traffic zone L2 are driving lanes (non-passing lanes), and a third vehicle traffic zone L3 is a passing lane. Then, the own vehicle 100 is traveling in the first vehicle traffic zone L1 (driving lane), and the surrounding vehicle 110 located ahead of the own vehicle 100 in the traveling direction and on the right side of the own vehicle 100 is traveling in the second vehicle traffic zone L2 (driving lane). In addition, in FIG. 5, the total number of lanes is three on each side, the first vehicle traffic zone L1 and the second vehicle traffic zone L2 are the driving lanes, and the third vehicle traveling zone L3 is the passing lane. Then, the own vehicle 100 is traveling in the second vehicle traffic zone L2 (driving lane), and the surrounding vehicle 110 located ahead of the own vehicle 100 in the traveling direction and on the right side of the own vehicle 100 is traveling in the third vehicle traveling zone L3 (passing lane).

First, the ECU 20 acquires information related to traveling lanes of the own vehicle 100 and the surrounding vehicle 110 (Step S1). Then, the ECU 20 determines whether the surrounding vehicle 110 is traveling on the passing lane (Step S2). For example, as illustrated in FIG. 5, in a case of determining that the surrounding vehicle 110 is traveling on the passing lane (Yes in Step S2), the ECU 20 does not propose to follow the surrounding vehicle 110 (Step S3). Then, the ECU 20 ends the series of control. On the other hand, for example, as illustrated in FIG. 4, in a case of determining that the surrounding vehicle 110 is not traveling in the passing lane (No in Step S2), the ECU 20 proposes to follow the surrounding vehicle 110 (Step S4). Then, the ECU 20 ends the control of the example.

In the platoon traveling system according to the embodiment, the ECU 20 of the own vehicle 100 determines the traveling lane of the surrounding vehicle 110 and does not propose to follow the surrounding vehicle 110 traveling on the passing lane, whereby the own vehicle 100 can be prevented from keeping traveling on the passing lane in the platoon traveling. In addition, in the platoon traveling system according to the embodiment, in a case where the passing lane is on the rightmost side, it may not be proposed to follow a surrounding vehicle traveling in the lane on the right side of the own vehicle 100 in the traveling direction.

In addition, in the platoon traveling system according to the embodiment, after the ECU 20 of the own vehicle 100 proposes to follow the surrounding vehicle 110 that is not traveling on the passing lane, in a case where the surrounding vehicle 110 changes the lane to the passing lane, control to make a proposal to stop following the surrounding vehicle 110 may be performed.

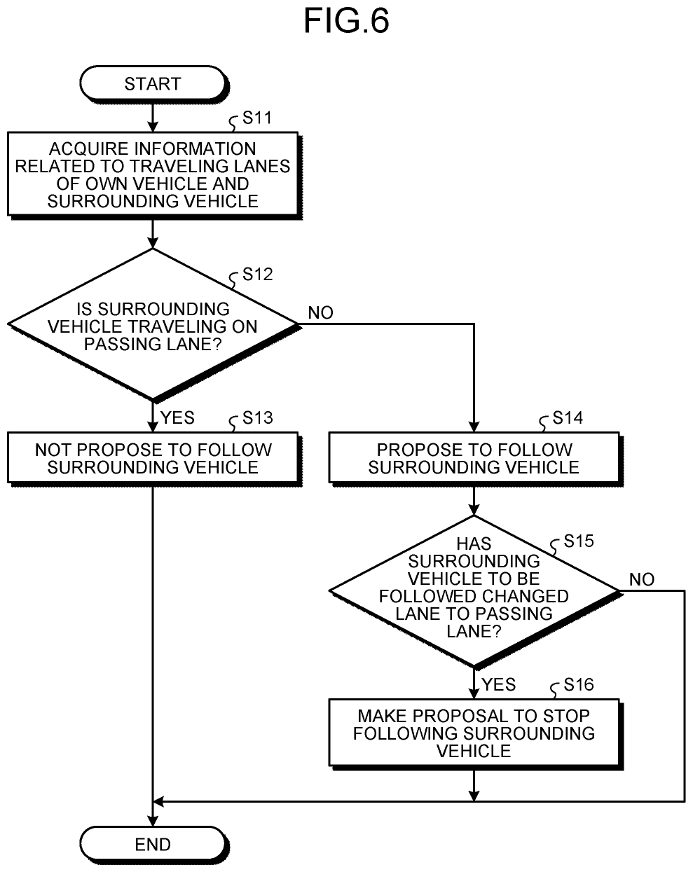

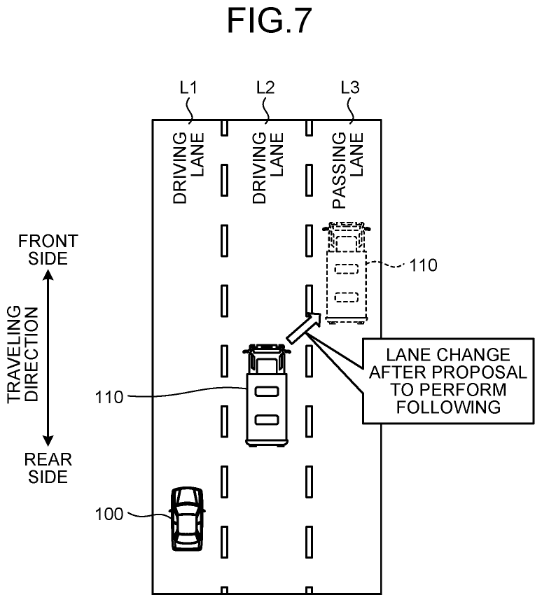

FIG. 6 is a flowchart illustrating a second example of the control executed by the ECU 20 in the own vehicle 100 when a preceding vehicle in the platoon traveling is selected from the surrounding vehicles. FIG. 7 is a view illustrating a case where the surrounding vehicle 110 not traveling on the passing lane changes the lane to the passing lane after a proposal to follow the surrounding vehicle 110 is made. Note that in FIG. 7, the total number of lanes is three on each side, the first vehicle traffic zone L1 and the second vehicle traffic zone L2 are the driving lanes, and the third vehicle traffic zone L3 is the passing lane. Then, the own vehicle 100 is traveling in the first vehicle traffic zone L1 (driving lane), and the surrounding vehicle 110 located ahead of the own vehicle 100 in the traveling direction and on the right side of the own vehicle 100 is traveling in the second vehicle traffic zone L2 (driving lane). Then, in FIG. 7, after the ECU 20 of the own vehicle 100 proposes to follow the surrounding vehicle 110 traveling in the second vehicle traffic zone L2 (driving lane), the surrounding vehicle 110 makes a lane change to the third vehicle traffic zone L3 (passing lane) as indicated by a broken line in FIG. 7.

First, the ECU 20 acquires information related to the traveling lanes of the own vehicle 100 and the surrounding vehicle 110 (Step S11). Then, the ECU 20 determines whether the surrounding vehicle 110 is traveling on the passing lane (Step S12). In a case of determining that the surrounding vehicle 110 is traveling on the passing lane (Yes in Step S12), the ECU 20 does not propose to follow the surrounding vehicle 110 (Step S13). Then, the ECU 20 ends the series of control.

On the other hand, for example, as illustrated in FIG. 7, in a case of determining that the surrounding vehicle 110 is not traveling on the passing lane (the surrounding vehicle 110 is traveling on the driving lane) (No in Step S12), the ECU 20 proposes to follow the surrounding vehicle 110 (Step S14). Then, the ECU 20 determines whether the surrounding vehicle 110 to be followed has changed the lane to the passing lane (Step S15). In a case of determining that the surrounding vehicle 110 to be followed has not changed the lane to the passing lane (No in Step S15), the ECU 20 ends the series of control. On the other hand, for example, as indicated by the broken line in FIG. 7, in a case of determining that the surrounding vehicle 110 to be followed has changed the lane to the passing lane (Yes in Step S15), the ECU 20 makes a proposal to stop following the surrounding vehicle 110 (Step S16). Then, the ECU 20 ends the series of control.

In the platoon traveling system according to the embodiment, after the ECU 20 of the own vehicle 100 proposes to follow the surrounding vehicle 110 that is not traveling on the passing lane, in a case where the surrounding vehicle 110 changes the lane to the passing lane, it is possible to prevent the own vehicle 100 from keeping traveling on the passing lane in the platoon traveling by making a proposal to stop following the surrounding vehicle 110.

Furthermore, in a case where the surrounding vehicle 110 not traveling on the passing lane changes the lane to the passing lane after the proposal to follow the surrounding vehicle 110 is made, the ECU 20 of the own vehicle 100 may not make the proposal to stop following the surrounding vehicle 110 when the own vehicle 100 has already started a lane change to follow the surrounding vehicle 110.

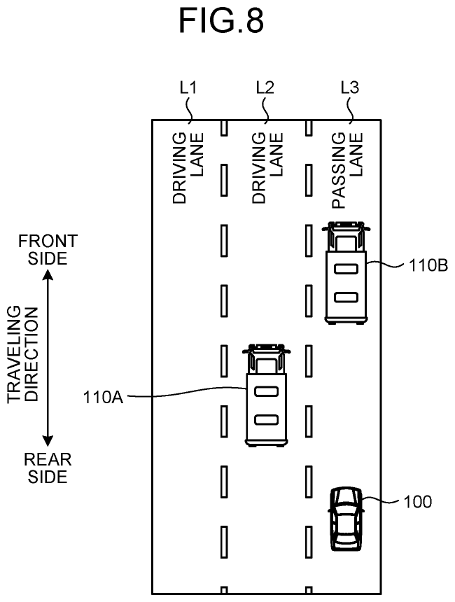

FIG. 8 is a view illustrating a case where the own vehicle 100 is traveling on the passing lane. Note that in FIG. 8, the total number of lanes is three on each side, the first vehicle traffic zone L1 and the second vehicle traffic zone L2 are the driving lanes (non-passing lanes), and the third vehicle traffic zone L3 is the passing lane in order from the left side in the traveling direction of the three lanes. Then, the own vehicle 100 is traveling in the third vehicle traffic zone L3 (passing lane), a surrounding vehicle 110A located ahead of the own vehicle 100 in the traveling direction and on the left side of the own vehicle 100 is traveling in the second vehicle traffic zone L2 (driving lane), and a surrounding vehicle 110B located ahead of the surrounding vehicle 110A in the traveling direction and on the right side of the surrounding vehicle 110A is traveling in the third vehicle traffic zone L3 (passing lane). That is, in FIG. 8, the surrounding vehicle 110B is traveling on the passing lane ahead of the own vehicle 100 traveling on the passing lane.

In the platoon traveling system according to the embodiment, as illustrated in FIG. 8, in a case where the own vehicle 100 is traveling on the passing lane (third vehicle traffic zone L3), the ECU 20 of the own vehicle 100 proposes to follow the surrounding vehicle 110A traveling on the driving lane (second vehicle traffic zone L2) that is not the passing lane, and does not propose to follow the surrounding vehicle 110B traveling on the passing lane (third vehicle traffic zone L3). As a result, it is possible to prevent the own vehicle 100 already traveling on the passing lane from further keeping traveling on the passing lane (third vehicle traffic zone L3) by the platoon traveling.

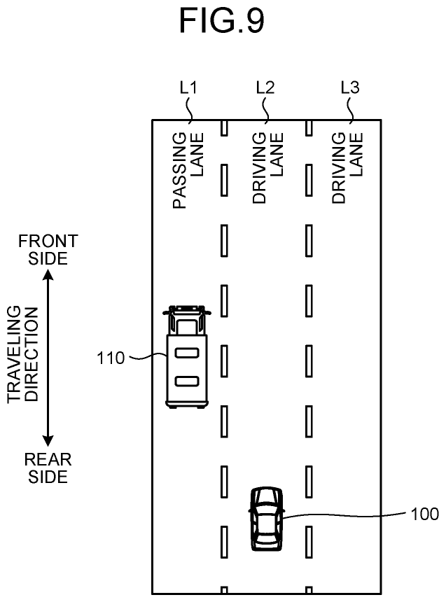

FIG. 9 is a view illustrating a case where the leftmost lane of the three lanes on each side is the passing lane. Note that in FIG. 9, the total number of lanes is three on each side, the first vehicle traffic zone L1 is the passing lane, and the second vehicle traffic zone L2 and the third vehicle traffic zone L3 are the driving lanes in order from the left side in the traveling direction of the three lanes. Then, the own vehicle 100 is traveling in the second vehicle traffic zone L2 (driving lane), and the surrounding vehicle 110 located ahead of the own vehicle 100 in the traveling direction and on the left side of the own vehicle 100 is traveling in the first vehicle traffic zone L1 (passing lane).

In the platoon traveling system according to the embodiment, as illustrated in FIG. 9, in a case where the leftmost lane of the three lanes on each side is the passing lane, the ECU 20 of the own vehicle 100 traveling on the driving lane (second vehicle traffic zone L2) does not propose to follow the surrounding vehicle 110 traveling on the passing lane (first vehicle traffic zone L1). As a result, in a case where the leftmost lane of the three lanes on each side is the passing lane, it is possible to prevent the own vehicle 100 from keeping traveling on the passing lane (first vehicle traffic zone L1) in the platoon traveling. In addition, in the platoon traveling system according to the embodiment, in a case where the passing lane is on the leftmost side, it may not be proposed to follow a surrounding vehicle traveling on the lane on the left side of the own vehicle 100 in the traveling direction.

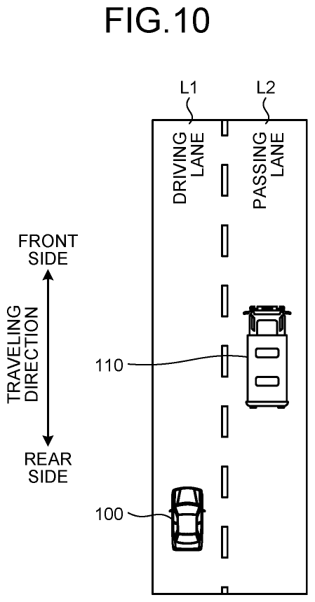

FIG. 10 is a view illustrating a first example of a case where the total number of lanes is two on each side. In FIG. 10, the total number of lanes is two on each side, and a first vehicle traffic zone L1 is a driving lane and a second vehicle traffic zone L2 is a passing lane in order from the left side of the two lanes. Then, the own vehicle 100 is traveling in the first vehicle traffic zone L1 (driving lane), and the surrounding vehicle 110 located ahead of the own vehicle 100 in the traveling direction and on the right side of the own vehicle 100 is traveling in the second vehicle traffic zone L2 (passing lane).

In the platoon traveling system according to the embodiment, the ECU 20 of the own vehicle 100 recognizes the total number of lanes on the road on which the own vehicle 100 is traveling on the basis of the position information of the own vehicle 100 recognized by utilization of the GPS receiving unit 38, and the map information in the map database 39. Then, as illustrated in FIG. 10, in a case where the total number of lanes is two on each side and the own vehicle 100 is traveling on the driving lane on the left side in the traveling direction (first vehicle traffic zone L1) of the two lanes on one side, the ECU 20 does not propose to follow the surrounding vehicle 110 traveling on the passing lane on the right side in the traveling direction (second vehicle traffic zone L2) of the two lanes on the one side. In other words, in a case where the own vehicle 100 is traveling on the driving lane on the left side in the traveling direction (first vehicle traffic zone L1) of the two lanes on the one side, the ECU 20 does not propose to follow the surrounding vehicle 110 located on the right side of the own vehicle 100 in the traveling direction.

As a result, on the road with two lanes on each side, the ECU 20 does not propose to follow the surrounding vehicle 110 traveling on the right lane that is set as the passing lane or that is highly likely to be set as the passing lane, whereby it is possible to prevent the own vehicle 100 from keeping traveling on the passing lane in the platoon traveling.

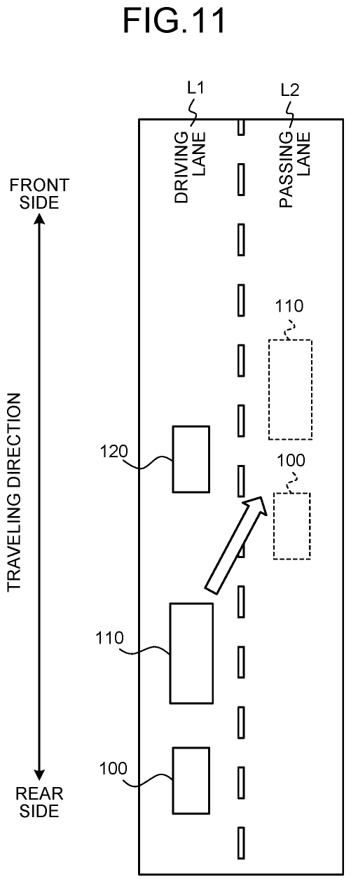

FIG. 11 is a view illustrating a second example of a case where the total number of lanes is two on each side. In FIG. 11, the total number of lanes is two on each side, and the first vehicle traffic zone L1 is the driving lane and the second vehicle traffic zone L2 is the passing lane in order from the left side of the two lanes. The own vehicle 100 and the surrounding vehicle 110 that is to be followed and that is located ahead of the own vehicle 100 in the traveling direction are traveling on the driving lane (first vehicle traffic zone L1). Furthermore, ahead of the surrounding vehicle 110, a low-speed vehicle 120 traveling at a lower speed than the own vehicle 100 and the surrounding vehicle 110 is traveling on the driving lane (first vehicle traffic zone L1).

The ECU 20 of the own vehicle 100 proposes to follow the surrounding vehicle 110 traveling on the driving lane (first vehicle traffic zone L1) on the basis of the position information of the own vehicle 100 recognized by utilization of the GPS receiving unit 38 and the map information in the map database 39. Then, the ECU 20 performs control to make a proposal to stop following the surrounding vehicle 110 in a case where the surrounding vehicle 110 changes the lane to the passing lane (second vehicle traffic zone L2) after the proposal to follow the surrounding vehicle 110 is made and the own vehicle 100 follows the surrounding vehicle 110 and keeps traveling on the passing lane (second vehicle traffic zone L2) for a predetermined time or a predetermined distance.

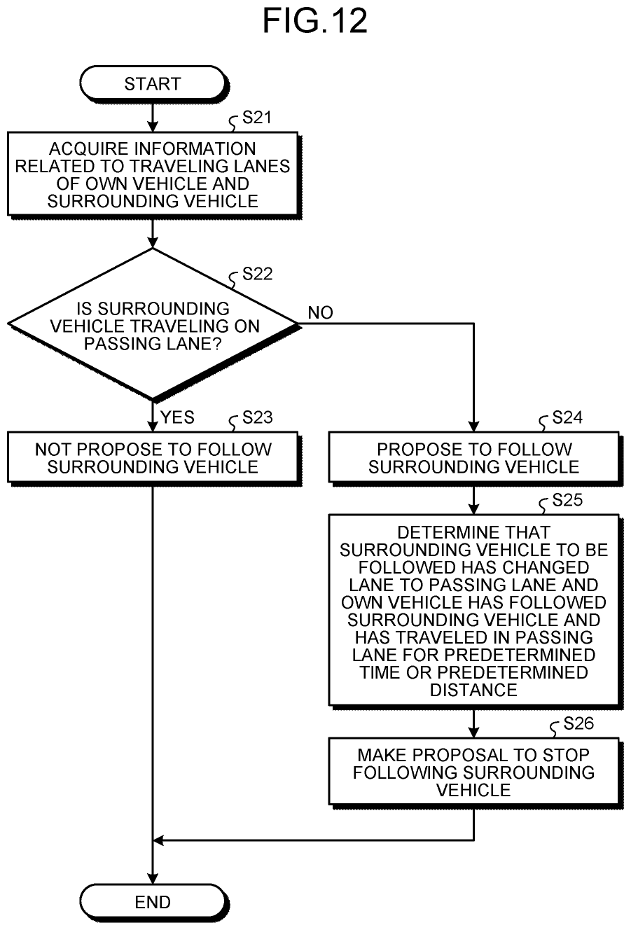

FIG. 12 is a flowchart illustrating a third example of the control executed by the ECU 20 in the own vehicle 100 when a preceding vehicle in the platoon traveling is selected from the surrounding vehicles.

First, the ECU 20 acquires information related to the traveling lanes of the own vehicle 100 and the surrounding vehicle 110 (Step S21). Then, the ECU 20 determines whether the surrounding vehicle 110 is traveling on the passing lane (Step S22). For example, in a case of determining that the surrounding vehicle 110 is traveling on the passing lane (Yes in Step S22), the ECU 20 does not propose to follow the surrounding vehicle 110 (Step S23). Then, the ECU 20 ends the series of control.

On the other hand, in a case of determining that the surrounding vehicle 110 is not traveling on the passing lane (the surrounding vehicle 110 is traveling on the driving lane) (No in Step S22), the ECU 20 proposes to follow the surrounding vehicle 110 (Step S24). Then, the ECU 20 determines that the surrounding vehicle 110 to be followed changes the lane to the passing lane and the own vehicle 100 follows the surrounding vehicle 110 and travels in the passing lane for a predetermined time or a predetermined distance (Step S25). Then, the ECU 20 makes a proposal to stop following the surrounding vehicle 110 (Step S26). Then, the ECU 20 ends the series of control.

As a result, in the platoon traveling system according to the embodiment, it is possible to prevent the own vehicle 100 from keeping traveling on the passing lane in the platoon traveling.

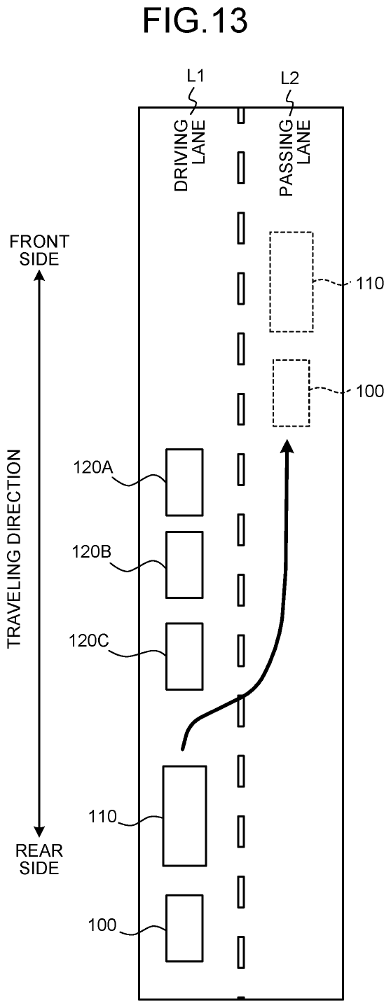

FIG. 13 is a view illustrating a third example of a case where the total number of lanes is two on each side. In FIG. 13, the total number of lanes is two on each side, and the first vehicle traffic zone L1 is the driving lane and the second vehicle traffic zone L2 is the passing lane in order from the left side of the two lanes. The own vehicle 100 and the surrounding vehicle 110 that is to be followed and that is located ahead of the own vehicle 100 in the traveling direction are traveling on the driving lane (first vehicle traffic zone L1). Furthermore, ahead of the surrounding vehicle 110, a plurality of low-speed vehicles 120A, 120B, and 120C traveling at a lower speed than the own vehicle 100 and the surrounding vehicle 110 are traveling on the driving lane (first vehicle traffic zone L1).

The ECU 20 of the own vehicle 100 proposes to follow the surrounding vehicle 110 traveling on the driving lane (first vehicle traffic zone L1) on the basis of the position information of the own vehicle 100 recognized by utilization of the GPS receiving unit 38 and the map information in the map database 39. Then, in a case where the surrounding vehicle 110 changes the lane to the passing lane (second vehicle traffic zone L2) after the proposal to follow the surrounding vehicle 110 is made, the ECU 20 performs control to make a proposal to stop following the surrounding vehicle 110 after determining that the own vehicle 100 follows the surrounding vehicle 110 and travels on the passing lane (second vehicle traffic zone L2) and passing of the plurality of low-speed vehicles 120A, 120B, and 120C traveling on the driving lane (first vehicle traffic zone L1) by the own vehicle 100 is completed. Note that the ECU 20 determines whether the own vehicle 100 has passed the plurality of low-speed vehicles 120A, 120B, and 120C by, for example, detecting the plurality of low-speed vehicles 120A, 120B, and 120C with the in-vehicle camera or the like.

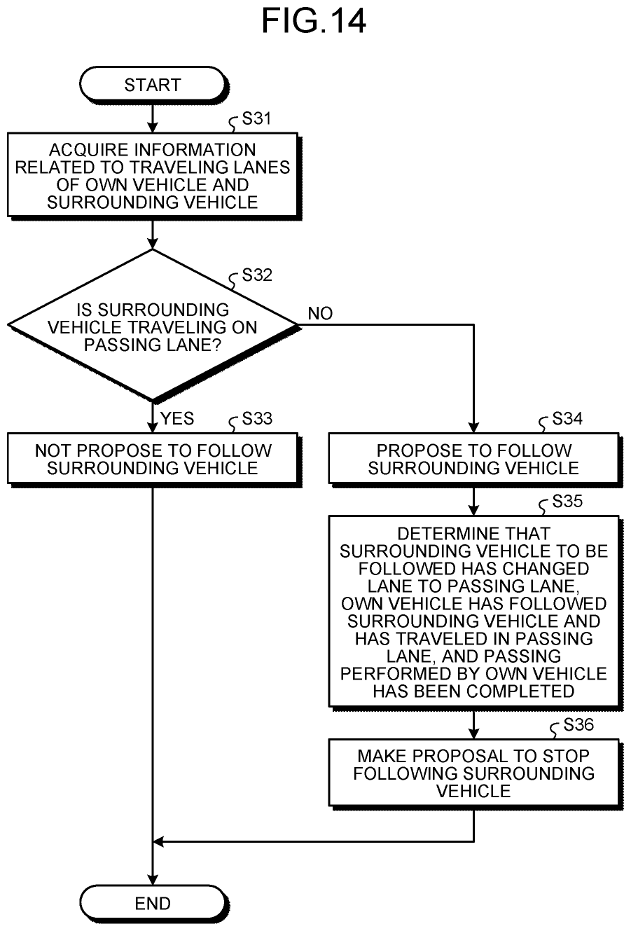

FIG. 14 is a flowchart illustrating a fourth example of the control executed by the ECU 20 in the own vehicle 100 when a preceding vehicle in the platoon traveling is selected from the surrounding vehicles.

First, the ECU 20 acquires information related to the traveling lanes of the own vehicle 100 and the surrounding vehicle 110 (Step S31). Then, the ECU 20 determines whether the surrounding vehicle 110 is traveling on the passing lane (Step S32). In a case of determining that the surrounding vehicle 110 is traveling on the passing lane (Yes in Step S32), the ECU 20 does not propose to follow the surrounding vehicle 110 (Step S33). Then, the ECU 20 ends the series of control.

On the other hand, in a case of determining that the surrounding vehicle 110 is not traveling on the passing lane (the surrounding vehicle 110 is traveling on the driving lane) (No in Step S32), the ECU 20 proposes to follow the surrounding vehicle 110 (Step S34). Then, the ECU 20 determines that the surrounding vehicle 110 to be followed has changed the lane to the passing lane, the own vehicle 100 has followed the surrounding vehicle 110 and traveled on the passing lane, and the own vehicle 100 has passed the plurality of low-speed vehicles 120A, 120B, and 120C traveling on the driving lane on the basis of a result of the detection by the in-vehicle camera or the like (Step S35). Then, the ECU 20 makes a proposal to stop following the surrounding vehicle 110 (Step S36). Then, the ECU 20 ends the series of control.

As a result, in the platoon traveling system according to the embodiment, it is possible to prevent the own vehicle 100 from keeping traveling on the passing lane in the platoon traveling.

The platoon traveling system according to the present disclosure has an effect of being capable of preventing the own vehicle from keeping traveling in the passing lane in the platoon traveling.

According to an embodiment, it is possible to prevent the own vehicle from keeping traveling in the passing lane in the platoon traveling.

According to an embodiment, the control device can recognize a lane on which each of the own vehicle and surrounding vehicle is traveling on the basis of the position information and the map information, and can recognize whether each of the own vehicle and the surrounding vehicle is traveling in the passing lane.

According to an embodiment, it is possible not to propose to follow a surrounding vehicle traveling in the passing lane that is highly likely to be set on a right side of lanes the total number of which is two on each side.

According to an embodiment, it is possible to recognize the lane on which each of the own vehicle and the surrounding vehicle is traveling on the basis of the image of the periphery of the own vehicle which image is captured by the imaging device.

According to an embodiment, it is possible to prevent the own vehicle from following the surrounding vehicle that changes the lane to the passing lane and keeping traveling in the passing lane in the platoon traveling.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A platoon traveling system comprising: a control device, provided in an own vehicle, that performs control to propose the own vehicle to follow a surrounding vehicle traveling around the own vehicle, wherein
the control device does not propose to follow the surrounding vehicle traveling on a passing lane.

2. The platoon traveling system according to claim 1, wherein the control device recognizes a lane on which each of the own vehicle and the surrounding vehicle is traveling on a basis of position information of each of the own vehicle and the surrounding vehicle and map information.

3. The platoon traveling system according to claim 2, wherein
the control device recognizes a total number of lanes on a road on which the own vehicle is traveling on a basis of the position information and the map information, and
in a case where the total number of lanes is two on each side and the own vehicle is traveling on a lane on a right side in a traveling direction out of the two lanes on one side, the control device does not propose to follow the surrounding vehicle traveling on a lane on a left side of the own vehicle in the traveling direction.

4. The platoon traveling system according to claim 1, wherein
the own vehicle includes an imaging device that captures an image of a periphery of the own vehicle, and
the control device recognizes the lane on which each of the own vehicle and the surrounding vehicle is traveling on a basis of the image captured by the imaging device.

5. A platoon traveling system comprising: a control device, provided in an own vehicle, that performs control to propose an own vehicle to follow a surrounding vehicle traveling around the own vehicle, wherein
the control device performs control to make a proposal to stop following the surrounding vehicle in a case where the surrounding vehicle makes a lane change to a passing lane after the control device proposes to follow the surrounding vehicle traveling on a lane other than the passing lane.

6. The platoon traveling system according to claim 5, wherein the control device performs control to make a proposal to stop following the surrounding vehicle in a case where the surrounding vehicle makes the lane change to the passing lane after the control device proposes to follow the surrounding vehicle traveling on the lane other than the passing lane and the own vehicle follows the surrounding vehicle and keeps traveling on the passing lane for a predetermined time or a predetermined distance.

7. The platoon traveling system according to claim 5, wherein the control device performs control to make a proposal to stop following the surrounding vehicle in a case where the surrounding vehicle makes the lane change to the passing lane after the control device proposes to follow the surrounding vehicle traveling on the lane other than the passing lane and after the control device determines that the own vehicle follows the surrounding vehicle and travels on the passing lane and the passing performed by the own vehicle is completed.
